(19) United States
(12) Patent Application Publication
(10) Pub. No.: US 2006/0020401 A1
(43) Pub. Date: Jan. 26, 2006

(54) Alignment and autoregressive modeling of analytical sensor data from complex chemical mixtures

(75) Inventors: Cristina E. Davis, Cambridge, MA (US); Robert D. Tingley, Ashland, MA (US); Melissa D. Krebs, Quincy, MA (US)

Correspondence Address: GOODWIN PROCTER LLP;PATENT ADMINISTRATOR, EXCHANGE PLACE, BOSTON, MA, 02109-2881, US

(73) Assignee: Charles Stark Draper Laboratory, Inc., Cambridge, MA (US)

(21) Appl. No.: 11/184,624

(22) Filed: Jul. 19, 2005

Related U.S. Application Data
(60) Provisional application No. 60/589,433, filed on Jul. 20, 2004.

(51) Int. Cl. G01N 31/00

(52) U.S. Cl. 702/30

(57) ABSTRACT

The invention provides methods for aligning and filtering chromatograms representative of complex mixture samples. In one embodiment, the invention includes identifying and matching related peaks to determine a temporal offset, and applying a nonlinear temporal shift to account for the offset. In other embodiments, the invention provides methods for smoothing chromatographic data by application of an autoregressive filter to provide improved signal-to-noise ratio, data compression, and resolution. The alignment and filtering methods may be performed separately or combined. In certain embodiments, the invention provides improved chromatographic pattern recognition capability and improved classification of samples of complex chemical and/or biological mixtures.

### PRIOR APPLICATIONS

The present application claims the benefit of U.S. Provisional Patent Application No. 60/589,433, filed Jul. 20, 2004, which is hereby incorporated by reference in its entirety.

### GOVERNMENT RIGHTS

This invention was made with government support under ARO Contract DAAD19-03-R-0004, awarded by Defense Advanced Research Projects Agency (DARPA), and under Cooperative Agreement DAAD17-02-2-0006, awarded by the Department of the Army. The government has certain rights in the invention.

### FIELD OF THE INVENTION

This invention relates generally to methods of analyzing chromatographic data. More particularly, the invention relates to methods of temporally aligning chromatograms and/or filtering chromatographic data.

### BACKGROUND OF THE INVENTION

Chromatographic data is used to classify substances by comparing data from unknown samples with data from known samples. Examining chromatographic data for complex mixtures is often a difficult and burdensome task. For example, in the case of gas chromatography (GC) and gas chromatography-mass spectrometry (GC-MS), variation among samples can occur depending on conditions such as the quality of the GC column, the reliability of the oven temperature, repeatability of sample injection technique, and fluctuation in the gas flows. These variations may cause imperfect alignment of the data when comparing runs. Where a complex mixture contains many components, there may be hundreds of peaks in a given chromatogram. Thus, it may be difficult to determine which peaks appear reproducibly across chromatograms if the files are misaligned.

Various methods for alignment of chromatographic data have been attempted, for example, piece-wise linear interpolation, dynamic time warping, correlation optimized warping, parametric time warping, and parallel factor analysis. Each of these methods has drawbacks.

Piecewise linear interpolation assumes simple linear shifts, whereas chromatograms containing hundreds of elutants are likely to be misaligned in a nonlinear fashion throughout the entire chromatogram. Thus, piecewise linear interpolation typically results in error when applied to chromatograms of complex mixtures.

Dynamic time warping (DTW) compares many points along the chromatogram, regardless of whether they correspond to a large peak or low-abundance noise. Because the noise will vary from run to run, it may be difficult to directly compare any areas of the chromatograms that consist predominately of low-abundance noise.

Correlation optimized warping (COW) is similar to piecewise linear interpolation. However, in correlation optimized warping, optimal alignment is determined by the correlation of aligned signal fragments. In this method, the chromatograms must be similar in order for the method to succeed. Furthermore, the method assumes simple linear shifts between components, which may lead to error.

Another method for aligning chromatograms is parametric time warping. In this method, one chromatogram is taken as the reference and the others are adjusted thereto by varying the three coefficients of a quadratic time warping function to achieve a least-squares fit. This method does not rely on choosing landmarks; however, because no landmarks are chosen, there is a possibility of misaligning files in which unrelated peaks occur at roughly the same time. Furthermore, parametric time warping generally does not correct gross misalignments.

Parallel factor analysis (PARAFAC) models chromatograms and allows for retention time shifts between samples, in an attempt to eliminate the need for alignment. However, parallel factor analysis may not converge in cases where the retention time shift is high. Furthermore, even where parallel factor analysis works well without alignment, any subsequent use of a pattern recognition and classification algorithm will still require aligned data.

The analysis of chromatograms of complex mixtures poses other difficulties in addition to alignment problems. For example, where a complex mixture contains many chemical components, some components will likely elute at the same time, leading to overlapping signals in the chromatographic data and making feature/pattern recognition difficult. Moreover, some components of the complex mixture may be present in high abundance while others may be present only in trace amounts, such that the signal may be difficult to distinguish from the instrument background and electronic noise.

Several methods for smoothing signals have been proposed to reduce signal noise. However, these methods have not necessarily been applied in the field of analytical chemistry. These methods include moving average filter, Savitzky-Golay filter, derivative filter, Automatic Mass spectral Deconvolution and Identification Software (AMDIS), component detection algorithm (CODA), and morphological score. Each of these methods have various drawbacks.

In a moving average filtering method, each point is replaced by an average of itself with a certain number of neighboring points. The noise reduction is greater where more points are used for averaging, but averaging a larger number of neighboring points increases the chance that low-energy signals may be obscured. Another difficulty of the moving average filter is that the approximation is linear, and peaks are often better fit with polynomial functions; however, the use of polynomial approximations are often computationally intense, and not worth the potential improvement in signal approximation.

The Savitzky-Golay filter uses a least squares prediction to minimize the error between a fitted curve and the actual data. Each data point is re-calculated and expressed as the sum of coefficients. Although the calculations are simpler, there is a concern of decreased resolution, which may be problematic when analyzing a sample that has hundreds of features that may overlap. The potential loss of resolution following application of the Savitzky-Golay filter is often not worth the reduction in noise that the filter affords.

A derivative filter finds inflection points of a signal and considers them to be the overlapping point of two closely-spaced peaks. This method has the effect of narrowing peaks, but also tends to amplify noise, and is a computationally intensive technique.

The National Institute of Standards and Technology created an algorithm that is part of their freely-available software package called AMDIS. This method may be used for detecting components present in low concentrations. However, this method relies on a steady level of background ions for correct peak identification. Many peaks may be identified that do not actually represent compounds.

CODA is commercially-available software that includes a deconvolution algorithm described in Windig et al., Anal Chem 68, 3602-3606 (1996). A disadvantage of this method is that the noise is determined by a threshold chosen by the user, and is therefore potentially subjective. Also, since background chromatograms are considered to be smooth (i.e. the abundance level does not vary dramatically over time), the application of CODA to an ion chromatogram that has one major peak with its remaining signal at a constant, low level may result in one or more meaningful peaks being erroneously ignored.

A similar method to CODA is the calculation of a morphological score. This method may present the same drawbacks as CODA.

An algorithm that will increase the signal-to-noise ratio so compounds present in low abundance can be better distinguished from noise is useful in the analysis of complex chemical mixtures, particularly where the mixtures contain components that co-elute, causing their signals to overlap.

There is a need for more accurate, more robust, faster, and less costly methods of aligning chromatographic data of complex chemical and/or biological mixtures. There is also a need for new chromatographic data filtering methods that diminish noise while retaining important information so that the data can be used for more accurate pattern recognition and sample classification. It is desired that such methods require minimal or no input by a skilled technician. It is further desired that such methods be applicable over a range of applications, obviating the need for extensive customization for each application.

### SUMMARY OF THE INVENTION

The invention provides improved methods of aligning chromatograms representative of complex mixture samples. For example, certain methods of the invention accurately identify related peaks among chromatograms and apply a nonlinear temporal shift to align the chromatograms. The invention also provides methods of smoothing chromatographic data by applying an autoregressive filter.

In certain embodiments, the invention offers improved alignment of chromatograms, increased signal-to-noise ratio, advantageous data compression, and/or increased resolution. This allows improved chromatographic pattern recognition capability and improved classification of samples of complex chemical and/or biological mixtures.

In one aspect, the invention provides a method for temporally aligning chromatograms representative of complex mixture samples, the method including the steps of providing first and second chromatograms; identifying pairs of related peaks in the first and second chromatograms; computing a temporal offset for each of two or more pairs of related peaks; and applying a nonlinear temporal shift based on the computed temporal offsets to align the first and second chromatograms. The invention optionally includes the step of classifying a complex mixture sample using at least a portion of at least one of the aligned chromatograms. The complex mixture sample may be, for example, a biological mixture. For example, the complex mixture sample may be plasma, blood, urine, or an extract of plasma, blood, or urine.

In one embodiment, applying the nonlinear temporal shift includes determining a nonlinear functional relationship between temporal offset and retention time based on the computed temporal offsets, and aligning the first and second chromatograms based on the nonlinear functional relationship. The nonlinear functional relationship may be, for example, a cubic spline interpolation or a cubic hermite interpolating polynomial (piecewise, or non-piecewise).

The step of identifying pairs of related peaks may involve, for example, identifying candidate pairs of peaks and determining whether the candidate pairs of peaks are related. Unrelated candidate pairs may then be rejected. Related peaks may be identified, for example, by imposing a minimum correlation between M/Z values of related peaks.

The step of identifying pairs of related peaks may be performed automatically. In one embodiment, the steps of identifying pairs of related peaks, computing the temporal offset, and applying the nonlinear temporal shift are performed automatically.

The first chromatogram may be, for example, a single chromatogram or a composite of two or more chromatograms. The first and second chromatograms may include discrete and/or continuous data. The first and second chromatograms may include, for example, gas chromatographic data and/or GC-MS data.

In another aspect, the invention provides a method for temporally aligning chromatograms representative of complex mixture samples, the method including the steps of providing a plurality of chromatograms; identifying sets of related peaks among at least two of the chromatograms; computing a temporal offset for each of at least two sets of related peaks; and applying a nonlinear temporal shift based on the computed temporal offsets to align the plurality of chromatograms.

In yet another aspect, the invention provides a method for filtering at least one chromatogram representative of a complex mixture sample, the method including the steps of providing a chromatogram representative of a complex mixture sample; and applying an autoregressive filter to process data from the chromatogram. The method optionally includes the step of classifying the complex mixture sample using at least a portion of the processed data. The complex mixture sample may be, for example, a biological mixture. For example, the complex mixture sample may be plasma, blood, urine, or an extract of plasma, blood, or urine.

Applying the autoregressive filter may include, for example, transforming chromatographic data from frequency domain data to time domain data and/or computing predictor parameters to determine an impulse response corresponding to data from the chromatogram. The method optionally includes identifying a feature of the chromatogram using the predictor parameters and/or applying a Fourier transform to the impulse response to obtain a model chromatogram.

In one embodiment, the method includes providing a plurality of chromatograms representative of complex mixture samples and applying the autoregressive filter to smooth data from the chromatograms. The method may further include computing predictor parameters to determine an impulse response for each of the chromatograms and, optionally, identifying a pattern in the chromatograms using the predictor parameters.

Application of the autoregressive filter may include increasing signal-to-noise ratio of the chromatogram without substantially broadening peaks of the chromatogram. The application of the autoregressive filter may include resolving at least partially-overlapping peaks of the chromatogram.

The chromatogram may include discrete and/or continuous data. The chromatogram may include, for example, gas chromatographic data and/or GC-MS data.

In yet another aspect, the invention provides a method for aligning and filtering chromatograms representative of complex mixture samples, the method including the steps of providing a plurality of chromatograms; applying a nonlinear temporal shift to align at least two of the chromatograms; and applying an autoregressive filter to smooth data from at least one of the aligned chromatograms. The method optionally includes the step of classifying a complex mixture sample using at least a portion of at least one of the aligned and smoothed chromatograms. The complex mixture sample may be, for example, a biological mixture. For example, the complex mixture sample may be plasma, blood, urine, or an extract of plasma, blood, or urine.

The step of applying the nonlinear temporal shift may include, for example, identifying related peaks from the chromatograms, computing temporal offsets corresponding to the related peaks, and determining the nonlinear temporal shift. The step of applying the autoregressive filter may include, for example, computing predictor parameters to determine an impulse response for each of the chromatograms and applying a Fourier transform to each of the impulse responses to obtain model chromatograms.

The chromatograms may include discrete and/or continuous data. The chromatograms may include, for example, gas chromatographic data and/or GC-MS data

The invention also provides an apparatus for . . . . The apparatus includes a memory that stores code defining a set of instructions, and a processor that executes the instructions to perform one or more methods of the invention described herein.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a schematic of a data classification system, for example, a chromatographic data classification system, without a preprocessor.

FIG. 2 is a schematic of a data classification system with a preprocessor, according to an illustrative embodiment of the invention.

FIG. 3 is a graph showing a portion of three total ion chromatograms before alignment, according to an illustrative embodiment of the invention.

FIGS. 4A, 4B, and 4C are graphs showing landmarks automatically selected for three samples, according to an illustrative embodiment of the invention.

FIGS. 5A, 5B, and 5C are graphs showing functional approximations of the amount of shift between pairs of data sets, according to an illustrative embodiment of the invention.

FIG. 6 is a graph showing a portion of the three total ion chromatograms from FIG. 3 after alignment according to an illustrative embodiment of the invention.

FIGS. 7A and 7B are graphs demonstrating principal component analysis of total ion chromatograms resulting from GC-MS analysis of headspace above plasma samples from two donors, according to an illustrative embodiment of the invention.

FIGS. 8A, 8B, and 8C are graphs demonstrating application of an alignment method to two unrelated files, according to an illustrative embodiment of the invention.

FIG. 9 is a schematic of an autoregressive filter, according to an illustrative embodiment of the invention.

FIG. 10 is a graph showing an error waveform calculated for model orders ranging from 1 to 1893, according to an illustrative embodiment of the invention.

FIG. 11 is a schematic of the application of an autoregressive filter to chromatographic data, according to an illustrative embodiment of the invention.

FIG. 12 shows a series of plots indicating a chromatogram, its autocovariance, and a resulting modeled chromatogram in the application of an autoregressive filter, according to an illustrative embodiment of the invention.

FIG. 13 shows a series of plots of chromatograms modeled using different model orders in the application of an autoregressive filter, according to an illustrative embodiment of the invention.

FIG. 14 is a graph showing improved resolution resulting from application of an autoregressive filter, according to an illustrative embodiment of the invention.

FIG. 15 is a graph comparing correlation coefficients for the autoregressive and Savitzky-Golay filters, according to an illustrative embodiment of the invention.

FIGS. 16A, 16B, and 16C are graphs showing complex roots of predictor coefficient vectors in the application of an autoregressive filter to chromatographic data of bacteria headspace, according to an illustrative embodiment of the invention.

FIG. 17 shows an expanded view of complex roots of predictor coefficient vectors in an application of an autoregressive filter to chromatographic data of bacteria headspace, according to an illustrative embodiment of the invention, where clusters of roots are circles, the upper expanded portion shows clusters that occur with both spaces, and the lower expanded portion shows clusters that appear species-specific.

FIG. 18 depicts a computer hardware apparatus suitable for use in carrying out the methods described herein, according to an illustrative embodiment of the invention.

### DETAILED DESCRIPTION

Chromatographic data obtained for samples of complex chemical (including biological) mixtures may be used to classify those mixtures and/or identify components of those mixtures. In analyzing chromatographic data, it is often necessary to use a pattern recognition algorithm for extraction of important features that correspond to a given component or state. The data may be assigned to a class based on how well its features match those of a reference. Ideally, the probability of the data being assigned to the correct class should approach one, and the probability of assignment to an incorrect class should approach zero.

If any of the features that help define a given state correspond to components that co-elute or are present in low abundance in a chromatogram, classification may prove difficult. This is because the signals may not be readily distinguished either from each other or from the surrounding noise. Reduction of noise can assist with component detection and pattern recognition by allowing signals to become clearer as compared to the smoothed background. However, it is important that the method used does not diminish relevant information present in the data, as this may confound pattern recognition.

The invention provides methods for temporally aligning and filtering chromatographic data, allowing for improved chromatographic pattern recognition capability and/or improved classification of samples of complex chemical and/or biological mixtures.

Throughout the description, where methods are described as having, including, or comprising specific steps, it is contemplated that, additionally, there are processes and methods of the present invention that consist essentially of, or consist of, the recited steps.

It should be understood that the order of steps or order for performing certain actions is immaterial so long as the invention remains operable. Moreover, two or more steps or actions may be conducted simultaneously.

The term “chromatogram,” as used herein, is understood to mean any set of chromatographic and/or spectral data, including, but not limited to, a plot of data. Chromatographic data may include discrete and/or continuous data.

The term “complex mixture,” or “complex chemical mixture,” as used herein, is understood to mean any mixture of two or more compounds. In certain embodiments, a complex mixture contains more than 5 compounds, more than 10 compounds, more than 20 compounds, more than 50 compounds, or more than 100 compounds.

The mention herein of any method, protocol, or publication, for example, in the Background section, is not an admission that the method, protocol, or publication serves as prior art with respect to any of the claims presented herein.

The following headers are provided as a general organizational guide and do not serve to limit support for any given element of the invention to a particular section of the Description.

I. Temporal Alignment of Chromatograms

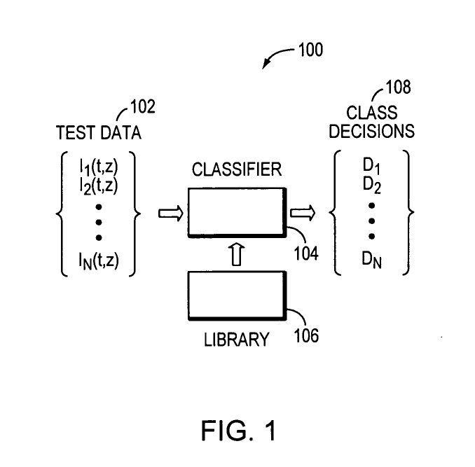

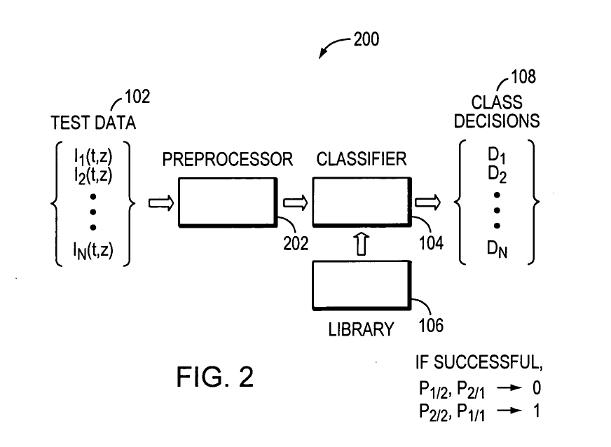

Pattern recognition depends on the ability to directly compare uniform data files. If the files are not aligned a pattern recognition algorithm may fail to recognize consistent signals simply because they are not found at the same location each time. FIG. 1 is a schematic 100 of a classification system in which known data files (i.e. a training set) are used to build a library 106. Test data 102 are then run through the classifier 104, which makes class decisions 108 based on the match to the library files. FIG. 2 is a schematic 200 of a classification system in which a preprocessor 202 is used to preprocess test data 102 in order to increase pattern recognition and classification success so that the probability of correct classification converges to unity. Thus, classification as portrayed in FIG. 1 will likely not be as successful as that portrayed in FIG. 2, where a pre-processing step to ensure that the files are uniformly distributed is performed before comparison to the library of known samples.

Alignment is an important step in the pre-processing of GC-MS data before classification. The retention time of a compound is dependent on its chemical properties and how it interacts with the phase of the column. In fact, the time at which a substance elutes from a given column can help with the compound identification. When comparing chromatograms, especially those that are from repeat runs, the identification of elutants depends on the mass spectra along with the retention time, as it is expected that given the same set of conditions, a compound should elute at the same time.

Misalignment in GC-MS data is rarely a simple linear shift. Most often there is extension and compression throughout the chromatogram at varying points. Thus, in one embodiment, an alignment protocol is chosen that compares points throughout the chromatogram, and also allows for non-linear interpolation.

In one embodiment, the alignment method scans data sets, looks for major peaks according to a user-set threshold, compares these peaks from chromatogram to chromatogram and computes correlation values, and then uses, for example, a cubic spline interpolator to align the data according to these landmarks. This method uses features present throughout the data, as the alignment will vary over time. It requires a minimum correlation in the M/Z dimension to ensure that the matched peaks are identical, in order to avoid falsely aligning peaks in unrelated chromatograms. The functional approximation allows for non-linear interpolation, a more realistic measure of the nature of the misalignment in chromatograms. This method of alignment is accurate, and it may be used effectively in the important step of pre-processing data prior to pattern recognition and classification.

In one embodiment, a reference file is selected to which all files will be aligned. The selection of a reference file should be one that seems representative of all files, in that there are no obvious extraneous events that cause it to deviate largely from other files. The main requirement is for all files to be aligned to the same vector (i.e. file) so they can then be compared directly to each other for further analysis such as classification. It is desired to have data sets that contain exactly the same features as all files that will be aligned to it so that alignment would be easier to perform. However, in the case of highly complex samples, and with slight instrument variation from day to day, the data will generally not be identical for different samples, even if they are from the same source (i.e. the same blood draw or urine donation). Given this variation, it is difficult or impossible to create a data set that would match all samples for use as a reference for alignment. As such, it is desired to use a best approximation for identifying an appropriate reference file to use for the alignment. Not every peak will be matched; it is desired to use only the peaks that can be matched to approximate the amount of shift that has occurred in the chromatogram, for example, due to temperature/flow variations. For this reason also, it is desired to employ a non-linear function to approximate the shift. Because it is generally not possible to match every point in the chromatogram, a nonlinear functional approximation of the shift between identified matching landmarks will be useful because it takes into account information of the amount of shift on either side of each landmark to determine the best functional fit.

In one embodiment, there are three user input parameters required for the alignment algorithm: the total ion abundance threshold of the peak picker, the maximum time offset allowed between identical landmarks from chromatogram to chromatogram, and the minimum correlation to consider landmarks identical. The alignment-by-landmarks method presented here can be implemented, for example, via software, to compare any number of peaks across chromatograms by adjusting the peak-picker threshold. A possible difficulty with matching peaks that have a very low total ion count (i.e. near the baseline) is that the background and noise present at such a level could dominate the spectra during the landmark matching procedure. As the signal is probably very similar across the chromatogram at the baseline, this would cause any matches that were made to be questionable in terms of matching unique peaks. Therefore, it is preferable to use a higher threshold that can select smaller peaks as well as the larger ones, but that is not so low that it is selecting ‘peaks’ in the baseline that will have a lot of background noise. The second input parameter, the maximum time offset, can help prevent peaks that would not be expected to match up from even being compared. However, it is found that even if this value is set much higher than the expected offset (even up to the length of the entire chromatogram, thereby allowing all peaks to be compared no matter their location), it generally does not adversely affect the alignment, especially when the correlation parameter is set to a high value as it helps prevent incorrect matches. For example, a chemical that elutes early in the chromatogram to be able to match with a completely different chemical that elutes much later. Although the time of elution may vary between runs, the order of elution should not change. Also, the correlation parameter offers flexibility regarding how similar the M/Z dimension should be for the landmarks to be considered matching; a high value requires the peaks to be the same for them to be matched for alignment. The method will avoid falsely aligning peaks that do not contain the same compounds if the user sets a stringent correlation value. It is unlikely that an unbounded function would represent actual chromatogram warping, and such a function should alert the user that there are not enough common compounds between the chromatograms. The correlation value could then be lowered so that more landmarks might be identified as matches. In one embodiment, a piecewise cubic interpolation function is used to allow a nonlinear curve between points, while being constrained so that it will not overshoot any points. This may be done, for example, using a piecewise cubic hermite interpolating polynomial (PCHIP) function. An advantage of using a cubic spline function is that the second derivative is continuous, creating a smooth function. An advantage of using a piecewise cubic polynomial function is that it will generally not overshoot any points, and if the data is not smooth there will be less oscillation in the function.

In one embodiment, the user selects a total ion abundance above which they want to search for peaks. Setting this threshold to find the largest peaks in the chromatograms may have the benefit of higher reproducibility. In addition to insuring a high number of compared landmarks throughout the chromatogram, the method allows for non-linear interpolation between them, accommodating the varying levels of extension or compression that may occur from landmark to landmark in a non-linear fashion. Unmatched peaks are ignored for the purpose of alignment. However, the number of peaks that are identified by the peak-picking algorithm may be determined and then compared to the number of matched peaks in order to determine similarity of the chromatograms.

II. Experimental Examples—Alignment of Chromatograms

The analysis of volatiles above plasma and urine is of interest for many medical applications. Experiments were conducted to measure the volatiles in the headspace above plasma using gas chromatography—mass spectrometry. The files were aligned using the described alignment method, and the resulting aligned chromatographs analyzed using principal component analysis (PCA). The PCA results demonstrate the effect of alignment on two groups of samples, where each group represents repeat samples from one individual donor. Eight samples were obtained from Donor A and ten samples were obtained from Donor B.

Sample Preparation

Whole blood samples were collected from a 39-year-old female subject (Donor A) and a 33-year-old female subject (Donor B) with informed consent and processed to obtain plasma at The CBR Institute for Biomedical Research, Inc. (CBR; Boston, Mass.). 1 ml aliquots were then placed into 10-ml borosilicate vials and capped with polytetrafluoroethylene (PTFE)/silicone septa and aluminum crimp caps (Agilent; Palo Alto, Calif.), creating an airtight seal to trap the volatiles produced from the plasma. The vials were then frozen at −20° C. A urine sample was collected from a 23-year-old female subject with informed consent at CBR. 1 ml aliquots were immediately placed into 10-ml borosilicate vials and capped and frozen in a manner identical to the plasma samples. Urine was also collected from mice at Johns Hopkins University. The urine was collected into sterile cryovials by applying gentle abdominal pressure. Urine was stored at −80° C. until use.

Chemical Analysis of Samples

Solid Phase Micro Extraction (SPME) was used to concentrate the volatiles above the headspace of three of the plasma samples before analysis on an Agilent 6890 Gas Chromatograph—5973N Mass Spectrometer (GC-MS). Immediately prior to use, the samples were removed from the −20° C. freezer and placed in a 45° C. water bath. A 65 μm partially crosslinked polydimethylsiloxane/divinylbenzene SPME fiber (Supelco; Bellefonte, Pa.) was immediately placed in the headspace of the vial; volatiles from the plasma were allowed to adsorb to the fiber for one hour. The SPME was then retracted, removed from the vial, and placed in the inlet of the GC. An identical SPME extraction technique was used to analyze the human urine samples, except that the water bath temperature was set at 60° C. To extract the volatiles from the mouse urine samples, 50 μl of urine was placed in 450 μl of 25% NaCl and 1 ppm acetophenone in a 2 ml vial. The SPME fiber (65 μm crosslinked polydimethylsiloxane/divinylbenzene) was placed in the headspace of the vial for one hour. During the extraction the vial temperature was maintained at 65° C. and agitated using an eppendorf thermomixer.

The volatiles were separated on a DB-WAX column (0.25 mm i.d.×30 m×0.25 μm film thickness, Agilent). The GC oven temperature was programmed from 50° C., initially held for 5 min, to 100° C. at 25° C./min, held for 4 min, then ramped to 150° C. at 10° C./min, held for 6 min, then ramped to 205° C. at 5° C./min and held at this final temperature for 7 min. The inlet was operated in splitless mode at 250° C. and the SPME fiber remained in the inlet for 5 minutes. The carrier gas was helium at a flow rate of 2.0 ml/min. The MS was set to scan from 50-550 m/z with a threshold of 20. A scan is recorded every 0.34 seconds. The MS quad temperature was set to 150° C. and the MS source temperature 230° C.

Data Analysis Methods

The data analysis was performed by codes written in MATLAB (The Mathworks, Inc., Natick, Mass.) software version 6.5.1.199709 Release 13. Prior to alignment, the raw data file from the MS is converted into cdf format using GC and GCMS File Translator Pro™ (ChemSW, Inc., Fairfield, Calif.). This is then converted into binary format as the data file will be smaller and easier to work with. This binary formatted file is read into MATLAB and the analysis begins. The data is first resampled along the M/Z axis to provide a uniform grid on which the subsequent analyses can be performed. An interpolation function is calculated such that its Fourier transform is identical to the Fourier transform of the non-uniformly sampled function.

There are three user input parameters required for the alignment algorithm: the total ion abundance threshold of the peak picker, the maximum time offset allowed between identical landmarks from chromatogram to chromatogram, and the minimum correlation to consider landmarks identical. These parameters were set to 150,000 counts, 20.0 seconds, and 0.99, respectively, for this study. For these examples, the peak threshold value was chosen such that only the largest peaks in the chromatogram would be selected, the maximum time offset was chosen based on maximum expected time drift in these chromatograms seen experimentally, and the minimum correlation was chosen to provide a high degree of confidence in the matching of the M/Z dimension. Depending on the desired tightness of fit when comparing landmarks, the correlation value can be increased or decreased accordingly.

A total ion chromatogram is a vector created by summing the abundance recorded at all M/Z values for each scan in time. In one embodiment, the alignment method first identifies peaks in the total ion chromatograms that are above the peak threshold value. The time value at which each of these peaks are considered to elute is calculated by determining the time at which the maximum height of the peak occurs. All peaks are then compared between the two files by looking back in the original M/Z vector. The peaks that are found to be highly similar in this dimension based on the calculation of a correlation coefficient will be matched. The peaks are compared in this order: the first peak in the reference TIC is selected, and the algorithm will scan through all peaks within the allowed maximum time offset for a match, starting from the earlier portion of the sample TIC and moving toward the later portion until a match is identified or it is determined that there is no match for that peak. A functional approximation based on the use of either the cubic spline (csape) from the Spline Toolbox or the piecewise cubic hermite interpolating polynomial (pchip) included with the standard software is then calculated to describe the shift between the matching peaks. This function is applied to the retention time axis to shift the data by the calculated amount at each point in time. The data can then be written out to a new file using the new time axis and the original data matrix and original M/Z axis. Alternatively, if it is necessary to have equal time values for all curves, the aligned file can be interpolated to a uniform matrix so that all files are on an identical grid. For the subsequent PCA analysis, equal time values were required for all curves. Therefore, just as for the M/Z axis, this interpolation of the time axis was performed using an interpolation function whose Fourier transform is identical to the Fourier transform of the non-uniformly sampled function.

For the principal component analysis, all files from both donors were aligned to a single file from Donor A. After alignment, the files were resampled onto a common time axis. Principal component analysis was performed on the total ion chromatograms using MATLAB's princomp function in the statistics toolbox. The projection of the data along the first and second principal components was examined.

### EXAMPLE 1

### Files from Donor A

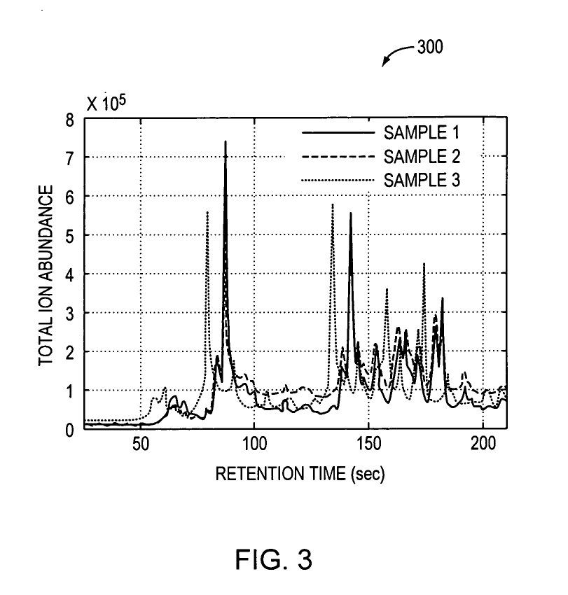

Three of the plasma samples from Donor A were analyzed by GC-MS. A portion of the total ion chromatograms for the samples used in SPME-GC-MS analysis are shown in the graph 300 of FIG. 3. The graph shows misalignment is apparent, even among the first peaks in the chromatograms. Samples 1 and 2 appear, by simple visual inspection, to be rather closely aligned, while sample 3 differs significantly from them. As all three of these samples are from the same plasma collection on a single day from a single patient, the volatiles would be expected to be the same. The samples should ideally produce the same chromatograms, with identical peaks occurring at very similar retention times. The only variation should be due to experimental variability, not sample content. In fact, there is some variation in the peaks between the samples, but these likely arise from the fact that the samples were not all run on the same day, but rather were spread out over a couple days with other donor samples run between them. Variability may be due to day-to-day variation of the equipment. For this reason, alignment is performed by choosing the larger, reproducible peaks that appear in each chromatogram as the landmarks. One file is used for reference, and another aligned to it.

During each scan of the MS, any components eluting from the GC column at that time will be recorded by measurement of their mass to charge (M/Z) ratio. However, the GC-MS data is recorded such that if an M/Z value is not identified, it is not recorded at all. If there is nothing detected for a given M/Z value, there is no placeholder employed to indicate an abundance of zero for that ion. Thus, the M/Z vector length varies from scan to scan, depending on what M/Z values were identified for the particular component that was eluting at each scan. As the test for peak equivalence evaluates the Euclidian norm numerically along a column, the evaluation will fail if the column units are either non-identical or not of the same dimension. For this reason, the data should be resampled prior to (or at the start of) the use of the alignment method. Each M/Z vector was resampled from 0 to 550.

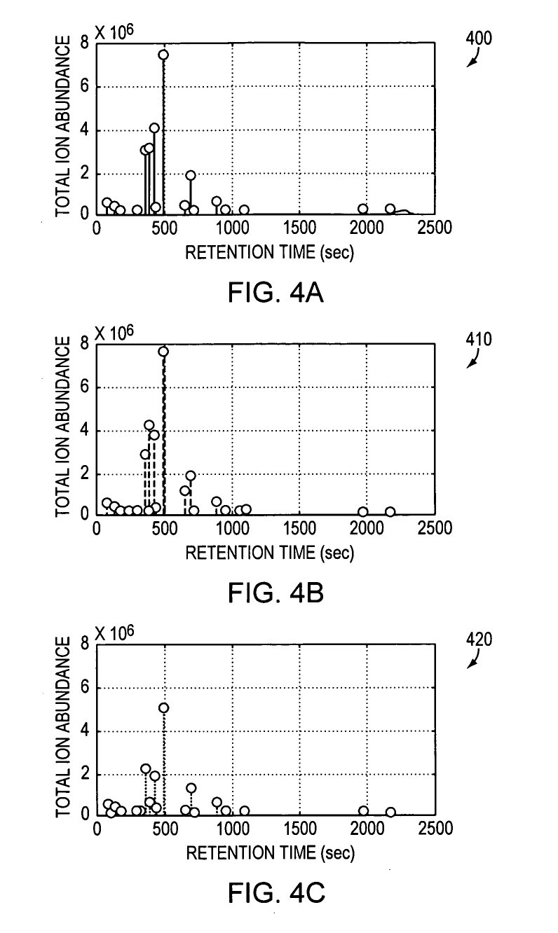

The features used for landmarks are found using a peak-picking algorithm: a threshold for minimum abundance is set and the algorithm automatically searches through the chromatogram and indicates all scans that have a total ion abundance greater than this threshold and also greater than the total abundances of the 9 chromatogram points before and after. FIGS. 4A, 4B, and 4C are graphs 400, 410, 420 showing landmarks that are automatically selected by the peak-picker for the three files in FIG. 3. A higher threshold was selected for the peak-picker so that only the largest peaks in the total ion chromatogram would be selected. Seventeen peaks were found in sample 1, twenty-six were found in sample 2, and twenty-three in sample 3. The landmarks are then compared across the samples by comparing a peak in the reference chromatogram to peaks in the other chromatogram sequentially, until an identical landmark is identified. For a feature to be considered identical, the method looks at the M/Z dimension and calculates the correlation of the corresponding vectors in the reference data and the test data being aligned to it. A minimum correlation is chosen and provides the decision on whether the landmarks are identical in the M/Z dimension, based on requiring a small Euclidian norm. A small Euclidian norm, or minimum integral of squared error along the M/Z dimension, is estimated by the maximum normalized correlation coefficient by assuming that the sensor error model follows a white Gaussian deviate. This normalizing allows landmarks to be matched even if their overall abundances are lower or higher than the reference file. Landmarks that are the same are reserved for alignment only to each other (i.e. so that they cannot be aligned again) and any landmarks not matched are disregarded for the purpose of alignment. Also, as the beginning and end of chromatograms often do not have large peaks, the functional approximation is extrapolated beyond the first and last matched landmarks. To do this, we assume that the shift at the first time point will be the equal to the shift between the first matched landmark in this data and the reference data. The same assumption is made for the shift between the last time point and the last matched landmark.

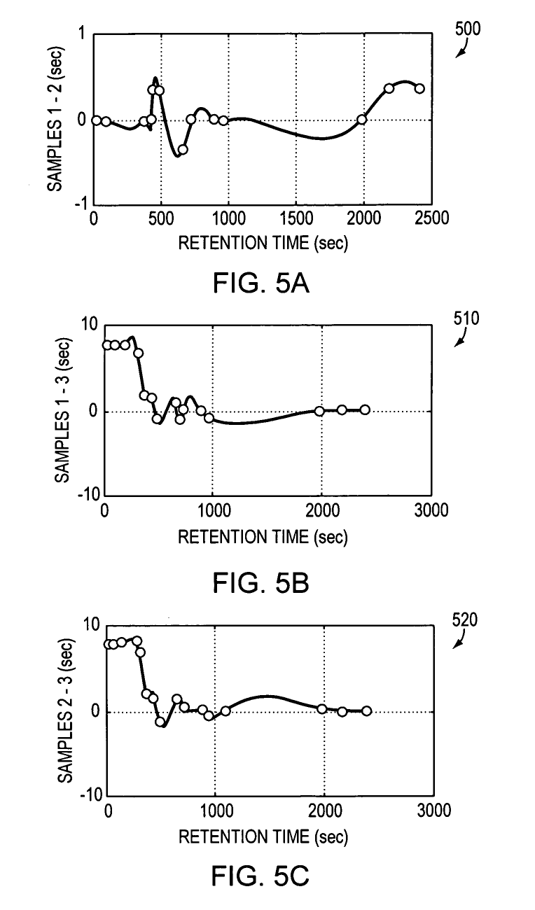

A maximum time offset is chosen to prevent peak-matching beyond reasonable shift. A time warping function is derived based on the distance of the landmarks in the reference file to those in another sample file. A cubic spline interpolator is used to create a functional approximation between the matching landmarks. This function is non-linear, as the misalignment is rarely a simple linear shift. FIGS. 5A, 5B, and 5C are graphs 500, 510, 520 showing functional approximations of the amount of shift between pairs of data sets. A cubic spline interpolator is used to calculate the nonlinear time shift between landmarks. The functional approximations shown in FIGS. 5A, 5B, and 5C demonstrate the misalignment of each file to each other. Samples 1 and 2 appear to be aligned in FIG. 3. This is also apparent in FIG. 5A, because all landmarks matched do not deviate from one another greatly beyond the resolution of the machine (0.34 seconds). This is even more apparent when comparing these files to that of sample 3 (FIGS. 5B and 5C). It appears that sample 3 was significantly misaligned (at least 8 seconds ahead of samples 1 and 2) for approximately the first six minutes of the run. After that point, the samples were closer but still different by up to two seconds, and again, the shift is nonlinear.

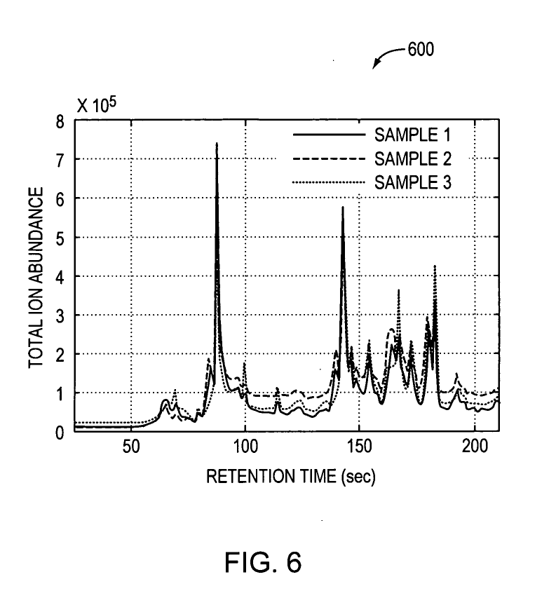

The functional approximations are then applied to the non-reference sample to align the two chromatograms. The graph 600 of FIG. 6 shows the three samples after alignment, again focusing only on the first few minutes of the chromatogram. The time warping function has effectively aligned the three chromatograms. This can be further verified by examination of the normalized dot product, calculated using Equation 1 as follows:

$$θ = \sum \frac{{V}_{1} * {V}_{2}}{\sqrt{\sum {V}_{1}^{2} * \sum {V}_{2}^{2}}} \qquad ( 1 )$$

The closer to one the angle is, the more similar the vectors are. The angle before alignment between samples 1 and 2 is 0.97, between samples 1 and 3 is 0.72, and between samples 2 and 3 is 0.70. After alignment, the angle between samples 1 and 2 is 0.97, and between samples 1 and 3 is 0.93, and between samples 2 and 3 is 0.90. The alignment brought the signal for sample 3 closer to samples 1 and 2.

### EXPERIMENT 2

### Files from Donor A and Donor B

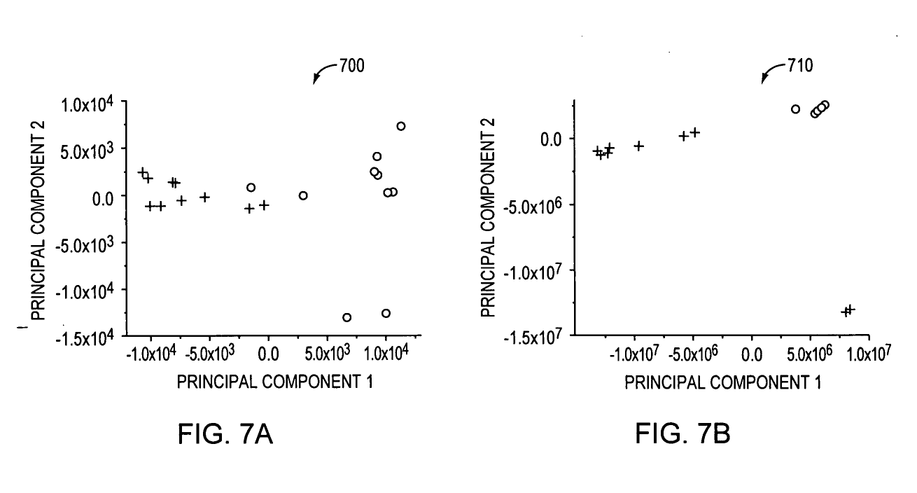

The effect of application of the alignment method on chromatographic data was demonstrated using data from two different donors. FIGS. 7A and 7B are graphs 700, 710 showing principal component analysis of total ion chromatograms resulting from GC-MS analysis of headspace above plasma samples from two donors. The graphs plot the scores for the first two principal components, with Donor A (+) and Donor B (O). Graph 700 shows separation before alignment and graph 710 shows separation after alignment. Before alignment, the samples are not as well separated as they are after alignment. Although the data from the two donors are relatively separated prior to alignment, there are several samples that overlap. After alignment the separation between the donors becomes much more evident, and the files cluster more tightly together for each donor than they did prior to the alignment. Furthermore, the first principal component alone would be sufficient for good separation after alignment, as seen in FIG. 7B. This demonstrates the utility of this algorithm for pre-processing of data prior to classification or other analysis.

### Experiment 3

### Files from Human Urine Volatiles and Mouse Urine Volatiles

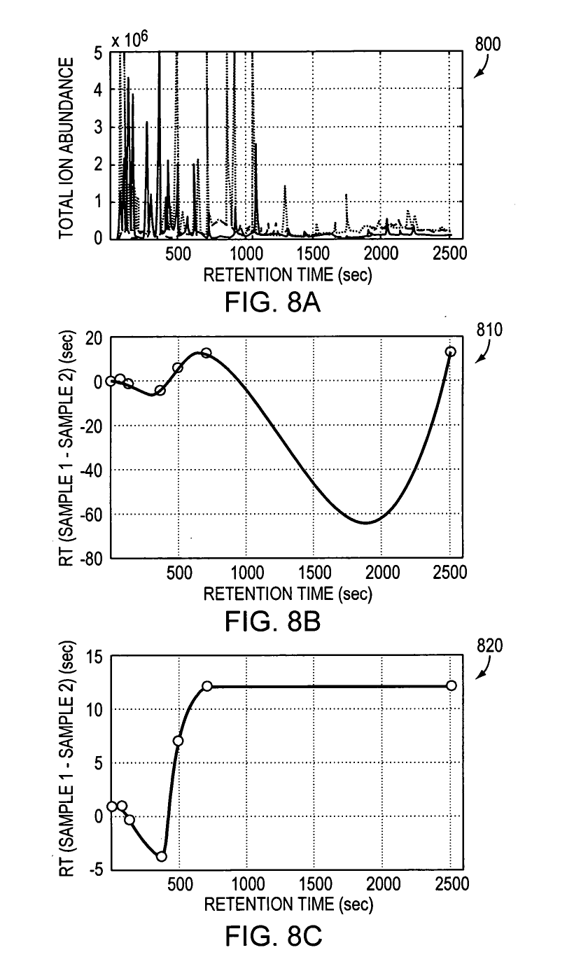

The alignment method was applied to chromatograms obtained for volatiles from two unrelated samples—a human urine sample and a mouse urine sample to demonstrate that the method would not incorrectly choose unrelated landmarks and force them to align. Both samples were run under the same GC conditions, but the samples were different. FIG. 8A shows a plot 800 of the total ion chromatograms from human urine volatiles (solid line) and mouse urine volatiles (dashed line). In FIG. 8A, the chromatograms are distinguishable by eye. When the alignment algorithm is applied to these two data sets, there are only 7 landmarks found to be well-correlated in the two samples. The compounds represented by these landmarks were identified using the NIST library and found to be siloxanes, which come from the SPME fiber, not from the samples themselves. This indicates that the only landmarks found to be identical between the unrelated samples was the background from the machine (probably due to the SPME fiber itself). In a preferred embodiment, the alignment method does not allow the forced alignment of the two chromatograms based on peaks that elute at roughly the same time; it requires the peaks to be matched in the M/Z dimension based on the user's choice of a desired correlation value to ensure that only those peaks resulting from the same chemical compound will be matched for alignment. FIG. 8B shows a plot 810 of a functional approximation of shift between the data sets using a cubic spline. Circles represent landmarks identified as matches in both chromatograms, and the line represents the functional approximation. The y-axis shows the amount of shift between the two files in seconds. FIG. 8B shows that the functional approximation is not constrained when two of the landmarks are spaced far apart. The small number of landmarks found that could be used for alignment of these two unrelated samples, and the resulting unbounded interpolation function, indicate that the samples are not well-correlated. If it is desirable to align two unrelated chromatograms and there are not many matching landmarks available to help define the functional approximation, there is also the possibility of using a piecewise cubic interpolation function, which will constrain the function, as shown in FIG. 8C. FIG. 8C shows a plot 820 of a functional approximation of shift between the data sets using a piecewise cubic hermite interpolating polynomial function. However, this function is not as smooth as the one produced by a cubic spline, in this example.

It is now possible to determine how many peaks were selected from the peak-picking algorithm and then compare that number to how many were matched to get a better measure of the similarity of the chromatograms. For instance, when comparing two samples from one donor (FIGS. 3-6), almost every peak that was selected for sample 1 (17 peaks total) was matched with a corresponding peak in samples 2 and 3. However, when looking at the mouse and human urine comparison (FIGS. 8A and 8B) only 7 landmarks were identified, and close examination revealed that those landmarks are due to the SPME fiber compounds, and are not sample-specific compounds. Thus, the method can identify whether the data corresponds to different chemical/biological mixtures.

III. Autoregressive Filtering of Chromatograms

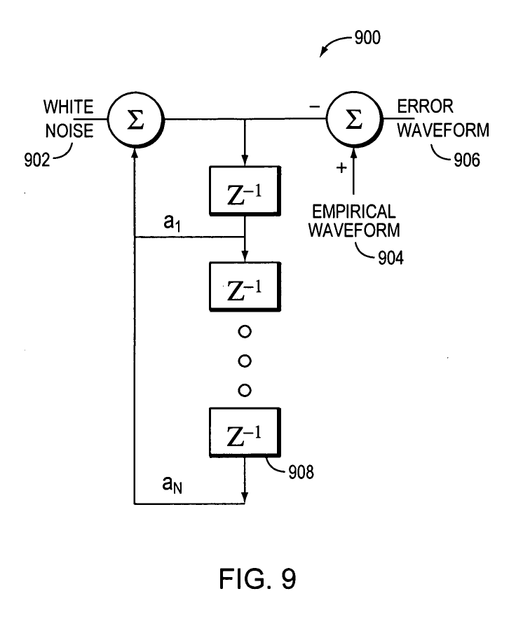

In one embodiment, an autoregressive (AR) filter is applied to process data from a chromatogram. The AR filter relates noise to the observed response at a given time and develops a model for the data based on this comparison. FIG. 9 is a schematic 900 of an autoregressive model form. The empirical waveform 904 is the chromatogram, which is used as input to build a model chromatogram based on white noise input 902. an error waveform 906 is calculated based on the similarity of the calculated model to the empirical waveform 904. the parameters aₙ represent the predictor coefficients of the autoregressive model, and Z⁻¹ at reference 908 is the transform that is iteratively performed on the data. AR filtering may provide enhanced data resolution along with noise reduction and data compression, as applied to GC-MS data. The AR filter provides several benefits, including data compression and enhanced resolution of the data, which is useful for the deconvolution of overlapping peaks that have co-eluted. Furthermore, AR provides a reduction in signal noise, allowing the peaks to appear more clearly. In addition, AR modeling has a further advantage of providing the opportunity for pattern recognition in parameter space.

Linear prediction is used in time series analysis; the signal is predicted from linear combinations of previous inputs and outputs. The model built by these predictions is called the AR model, and is also known as the all-pole model. For this model, the predictor coefficients and the gain must be determined in some manner, and the input is known. For example, if it is assumed that the input is totally unknown, then a least squares method may be used to predict the signal based on a weighted linear summation of past samples. The error between the actual and predicted values is calculated, and prediction coefficients are obtained by minimizing the error.

Linear prediction can be approached from either the time or the frequency domain. Additionally, it is possible to model discrete spectra, those that are recorded at a finite number of frequencies. The discrete-time data can be used to construct continuous-time models with the application of the least squares method.

In one embodiment, the chromatogram is considered at the onset to be in the frequency domain, as the frequency response of an AR filter can accurately represent narrowband peaks using relatively low-order models. In the usual procedure for estimating the vector of prediction coefficients, the linear system is solved in the time domain using the correlation samples. To get the correlation samples, the inverse Fourier transform of the magnitude-squared chromatogram is calculated.

The input signal is proportional to the error, so output signal energy equals that of the original signal, and total energy in the input signal can be specified. White noise is one type of input, assumed to be a sequence of uncorrelated samples with a mean of zero and a variance of one. The output forms a stationary random process for a fixed all-pole filter. Yule-Walker equations completely specify an all-pole random process. There are several ways to calculate the predictor parameters. After the predictor parameters have been calculated, the stability of the filter may be examined. If the predictor coefficients are positive definite, the filter will be stable. Also, in a preferred embodiment, the method checks rounding, as errors may be compounded and may affect the correlation matrix integrity. Additionally, as the number of samples increases, the filter will generally become more stable.

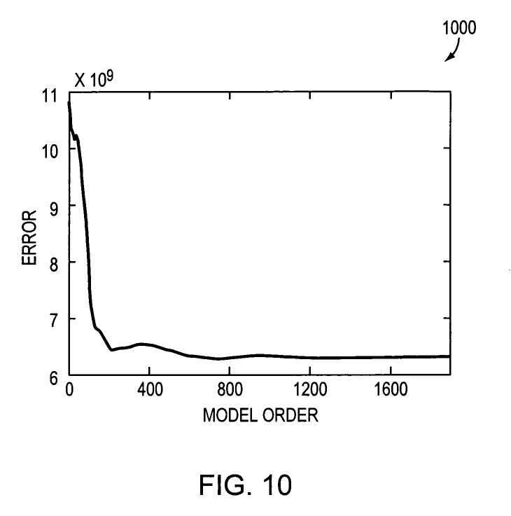

The optimal model order can be determined by an examination of the error at various model orders. The error is a measure of fit but not an absolute measure. The higher the model order, the greater the fit, but also the greater the computation time and the lower the data compression. When looking at error versus model order, the optimal model order can be determined from the point at which this curve reaches an asymptote of the lowest achievable error. For example, FIG. 10 shows an exemplary plot of error versus model order. The plot 1000 shows that the error decreases as the model order increases. If the model order is equal to the number of scans acquired, the error will be at an absolute minimum, because every scan has been modeled individually and so will be closely fit; however, there is no data compression advantage in this scenario. However, upon examining the graph of error at varying model orders, a minimum error may be achieved well before the model order is equal to the number of scans. Choosing an order that approaches this minimum asymptote may offer the best data compression with minimal loss of information.

IV. Experimental Examples—Autoregressive filtering of chromatograms

Experiments were conducted to demonstrate application of AR filtering to chromatographic data. The experiments demonstrate that the AR filter outperforms the Savitzky-Golay filter for smoothing noise while retaining important information within chromatograms, and also that AR correlation coefficients can be used to classify chromatogram data into groups.

Sample Preparation

Human plasma samples: Whole blood was collected from a 42-year-old male subject with informed consent, and the sample was processed to obtain plasma (CBR Institute for Biomedical Research; Boston, Mass.). 1 ml aliquots were placed into 10 ml borosilicate vials, capped with PTFE/silicone septa and aluminum crimp caps (Agilent; Palo Alto, Calif.), creating an airtight seal to trap the volatiles produced from the plasma. The vials were frozen at −20° C. until chemical analysis of the headspace was performed.

Bacteria headspace samples: GC-MS traces were recorded from concentrated headspace above vegetative bacteria cultures: Escherichia coli, Mycobacterium smegmatis, and Bacillus subtilis. The cultures were grown at 37° C. in 10 ml of liquid LB media contained in 20 ml borosilicate as described above. The cultures were analyzed after growing in septum-capped vials overnight.

Chemical Analysis of Samples

Human plasma sample analysis: 1 ml of headspace above the plasma was analyzed without concentration, using an automated headspace sampler (7694, Agilent) connected to the GC-MS. The vials were removed from −20° C. and placed into the headspace sampler: oven temperature of 45° C., loop temperature of 55° C., and transfer line temperature of 70° C.; event times were set as follows: vial equilibration, 25 min; pressurization, 0.1 min; loop fill, 0.5 min; loop equilibration, 0.1 min; injection, 0.2 min. Vial agitation was low. The GC column used was an HP5-MS (0.25 mm i.d.×30 m×0.25 μm film thickness, Agilent). The GC oven profile was 40° C. held for 4 min, ramped to 145° C. at 15.0° C./min, no final hold. The GC inlet was run in 1:1 split mode at 200° C. Helium was used as the carrier gas with a flow rate of 1.5 ml/min. The MS scanned from 50-550 m/z with a threshold of zero. The MS quad temperature was set to 150° C. and the MS detector temperature 230° C.

Bacteria headspace sample analysis: Solid Phase Micro Extraction (SPME) concentration of the culture headspaces was performed with a polydimethylsiloxane/divinylbenzene (PDMS/DVB) 65 μm Bonded Blue fiber (Supelco, Bellefonte, Pa.). The cultures were removed from the incubator and placed in a 60° C. water bath. The fiber was extended into the headspace of the culture and exposed for one hour. The SPME was retracted, removed from the vial, and placed in the inlet of the GC. The GC column was as above. The GC oven profile was 50° C. held for 5 min, ramped to 100° C. at 25° C./min and held for 4 min, ramped to 150° C. at 10° C./min and held for 6 min, then ramped to the final temperature of 205° C. at 5° C./min and held for 10 min. The inlet was operated in splitless mode at 250° C. and the SPME fiber remained in the inlet for 5 minutes. The MS scanned from 50-550 m/z with a threshold of 30. The carrier gas and MS detector temperatures were as above.

Data Analysis Methods

The data analysis was performed by codes written in MATLAB (The Mathworks, Inc., Natick, Mass.) software version 6.5.1.199709 Release 13. Fourier transforms were accomplished using the fast Fourier transform (FFT) algorithms included with the software. The Savitzky-Golay filter (sgolayfilt) included with the software was also used.

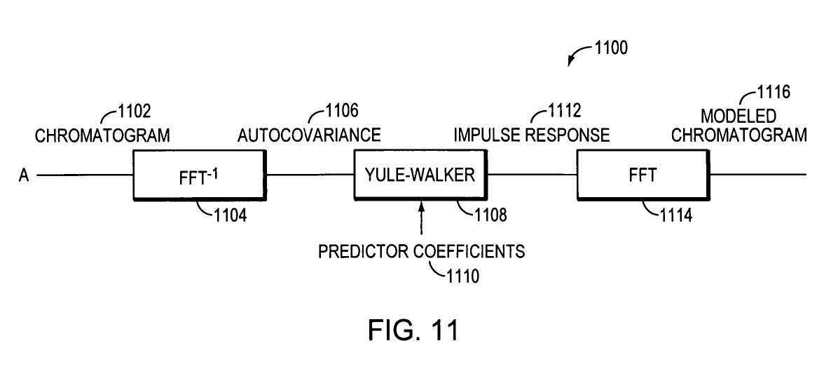

An AR filter was applied to each of the data sets, according to the general process illustrated in FIG. 11. FIG. 11 is a schematic 1100 of the application of an autoregressive filter to chromatographic data. The chromatogram 1102 is subjected to an inverse Fourier transform 1104 to calculate the autocovariance 1106. Yule-Walker equations 1108 with predictor coefficients 1110 as input are used to calculate the impulse response 1112, which is then transformed back to the frequency domain via Fourier transform 1114 to obtain the model chromatogram 1116.

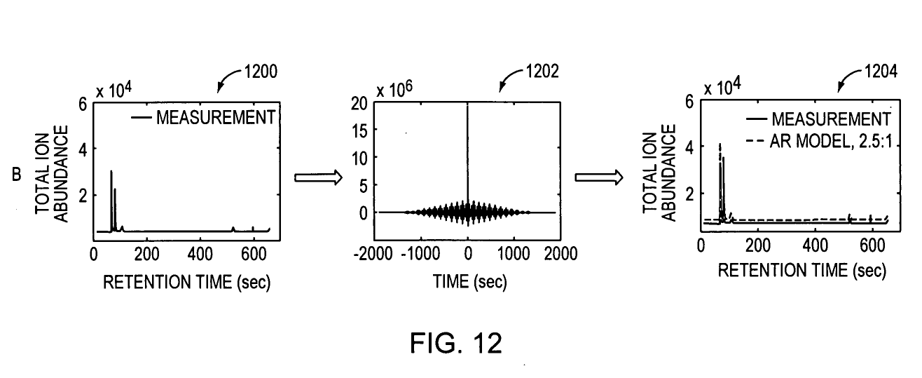

In one embodiment, the chromatogram is considered to be in the frequency domain, as discussed herein. The full Hermitian symmetric signal is calculated from this frequency response. This is then used to calculate the power spectrum, which is the Fourier transform of the correlation function. An inverse Fourier transform is taken of the power spectrum to calculate the correlation function, which represents the time waveform. For example, FIG. 12 shows a plot of a chromatogram 1200, its autocovariance 1202 and resulting modeled chromatogram 1204 according to the method of FIG. 11.

The functions X═FFT(x) and x=FFT⁻¹(X) implement the discrete Fourier transform and inverse transform pair for vectors of length N via Equations 2 and 3:

$$X ( k ) = {\sum }_{j = 1}^{N} x ( j ) {ω}_{N}^{( j - 1 ) ( k - 1 )} \qquad ( 2 )$$

$$x ( j ) = ( \frac{1}{N} ) {\sum }_{k = 1}^{N} X ( k ) {ω}_{N}^{- ( j - 1 ) ( k - 1 )} \qquad ( 3 )$$

where
ω_{N}=e^{(-πi)/N} is an N^{th} root of unity.

Predictor coefficients are calculated and used as input for the Yule-Walker equations to determine the impulse response. The predictor coefficients (aₙ) are calculated from the product of the inverse of the covariance matrix (Rₙ) with the covariance vector (rₙ). The covariance matrix is a Toeplitz matrix derived from the correlation function, and the covariance vector is taken from the correlation function based on the first model order, as shown in Equation 4:

$$[ \begin{matrix}{R}_{0} & {R}_{1} & … & {R}_{n - 1} \\ {R}_{1} & {R}_{0} & … & {R}_{n - 2} \\ … & … & … & … \\ {R}_{n - 1} & {R}_{n - 2} & … & {R}_{0}\end{matrix} ] [ \begin{matrix}{a}_{1} \\ {a}_{2} \\ … \\ {a}_{n}\end{matrix} ] = - [ \begin{matrix}{r}_{1} \\ {r}_{2} \\ … \\ {r}_{n}\end{matrix} ] \qquad ( 4 )$$

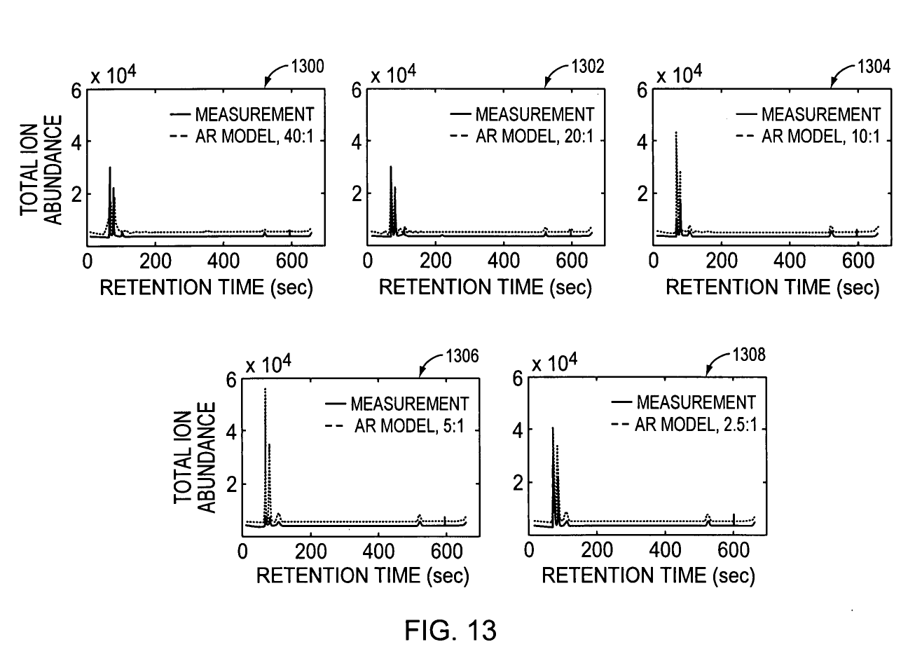

A Fourier transform is then taken of the impulse response to get the modeled chromatogram. The model order is defined by the ratio of modeled points to the original number of points in the raw data. The higher the model order, the more closely it will resemble the chromatogram. Data compression is defined as the inverse of model order. FIG. 13 shows plots 1300, 1302, 1304, 1306, and 1308 of chromatograms modeled using different model orders. The ratios shown in the legends represents the ratio of the number of discrete points in the original chromatogram to the model order. The lower the ratio, the more the model resembles the original chromatogram. As seen in FIG. 13, a higher order model will lead to more computation and less data compression. The peak amplitudes are not constrained in this example. If quantization is important for a particular application at hand, it is possible to constrain them to closely match the original amplitudes; however, this constraint may be made partially at the expense of increased resolution.

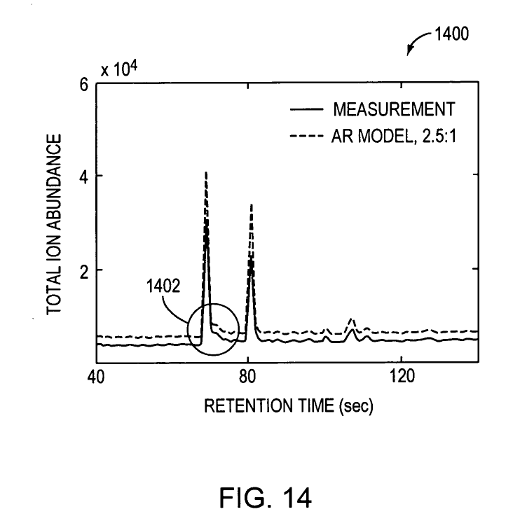

FIG. 14 shows a plot 1400 showing improved resolution of chromatographic data resulting from application of the autoregressive filter. The model shows a distinct peak 1402 directly following the first large peak in the chromatogram; in the original chromatogram, the smaller peak blends with the larger peak and looks like a shoulder of the larger peak. Because the AR filter incorporates white noise into the model, it is unlikely that a signal feature will be artificially-induced. Comparing the NIST database search results of the large and small peak, it is clear they are different chemicals. At 69.1 seconds, the highest NIST match is βPsi-Carotene-3′,4′didehydro-1′,2′dihydro-1′,2′dihydroxy with a match factor of 615. At 71.4 seconds, Rhodopin is the highest match with a match factor of 571.

The similarity of the model to the recorded data can be calculated by the sum of squared differences at each scan between the chromatograms. The error is calculated using this method for varying model orders to determine the lowest model order that should be used, using the equation: error=Σ[model(tₙ)−recorded(tₙ)]² from n=1 to the final time of the scan. In a plot of error versus model order (FIG. 10), the error will decrease as the model order increases. This plot will have the same trend for any data set, and can be used to determine an optimal model order: as the model order increases, the error approaches a minimum asymptote. The lowest model order at which this error falls within an acceptable error range can be used, as this will provide the greatest level of data compression with minimal error. Generally, the model order at which this curve approaches the minimum asymptote is ideal to use for smoothing.

Similarly, the signal to noise ratio (SNR) can be calculated using the following equation, where V is the recorded signal, V-bar is the modeled signal, and k is a scaling constant, calculated such that it minimizes the error between the modeled and recorded signals according to Equation 5 as follows:

$$SNR = 10 * {log}_{10} [ \frac{{\sum }_{i = 1}^{N} {V ( i )}^{2}}{{\sum }_{i = 1}^{N} [ V ( i ) - k {\overline{V} ( i )}^{2} ]} ] \qquad ( 5 )$$

The SNR at varying model orders will follow a trend inverse to the error calculations. The noise in these calculations is defined as the difference between the recorded signal (considered to contain both signal and noise) and the modeled signal (assumed only to have signal). For a data compression ratio of 40:1, the SNR is 3.2703; for 10:1 it is 22.7264; and for 2.5:1, the SNR is 27.3289. This demonstrates a tradeoff between increased data compression and SNR. The user may decide what SNR is desirable for the particular application and choose a model order accordingly. A plot of the SNR versus model order will generally approach an asymptote where the SNR is not dramatically improved with increasing model orders; the model order at which this curve approaches the maximum asymptote may then be chosen for use in smoothing.

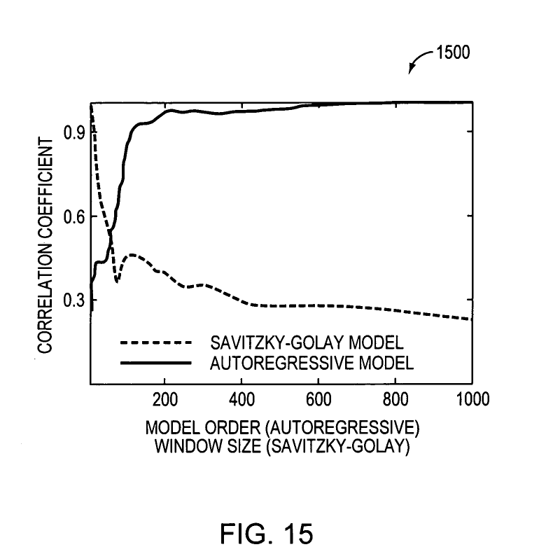

The performance of the AR filter was compared with performance of the Savitzky-Golay as applied to a common set of data. FIG. 15 shows a plot 1500 comparing the correlation coefficients for the autoregressive and Savitzky-Golay filters, calculated from the comparison of the filtered data with the original data. The AR filter uses a model order as a measure of how closely the original data will be modeled, while the Savitzky-Golay filter uses a polynomial order and a window size. The model order was allowed to vary for the AR filter; in the Savitzky-Golay filter, the polynomial order was set to 3 and the window size was allowed to vary. As seen in the graph, the trends are different, due to the effect the model parameters have on the filters. For the AR filter, a higher model order indicates less data compression due to more points being modeled, and thus a tighter fit of the model to the data. As seen in the figure, as the model order increases, the correlation of the model with the experimental data also increases. The correlation coefficient exceeds 0.9 for model orders that offer data compression in the range of 10:1 to 1:1. On the other hand, the Savitzky-Golay filter uses a window size that represents how many points will be averaged together to create the new smoothed points. So in this case, the larger the window size, the more smoothed the data is, and therefore the farther from the experimental data. For the smallest window size, the correlation of the model to the original chromatogram is almost 1.0. However, with this small window size, very little smoothing of the data is occurring, and thus the output is almost identical to the input, yielding little advantage of using the filter. As the window size increases, the correlation rapidly drops below 0.9 and remains very low through the remaining window sizes. The AR filter as applied here provides higher correlation of the model to the data with a minimal loss of information.

The roots of the predictor coefficients that are calculated and used to build the model of the data contain information about features of the raw data. For this reason, they offer a possible basis for pattern recognition and classification. Using a vector of the roots of the predictor coefficients for classification rather than using the raw data may offer the benefit of decreased computation time and also the possibility for increased performance of a classification algorithm, since each point contains information about a feature of the raw data, whereas the raw data itself contains both features and noise. When comparing two different chromatograms, the closer the roots of the predictor parameters are to each other the more likely that they are from the same sample. Thus, if there are roots that do not overlap from file to file, these could be used for classification.

The predictor parameters are used to build the AR model of the data. The roots of these parameter vectors contain information about the features of the chromatogram. For this reason, they can be used for pattern recognition. It is possible to detect certain microorganisms based on the volatiles they produce. Experiments were conducted to obtain chromatograms of bacteria headspace for AR modeling. The roots of the predictor coefficients were compared among species.

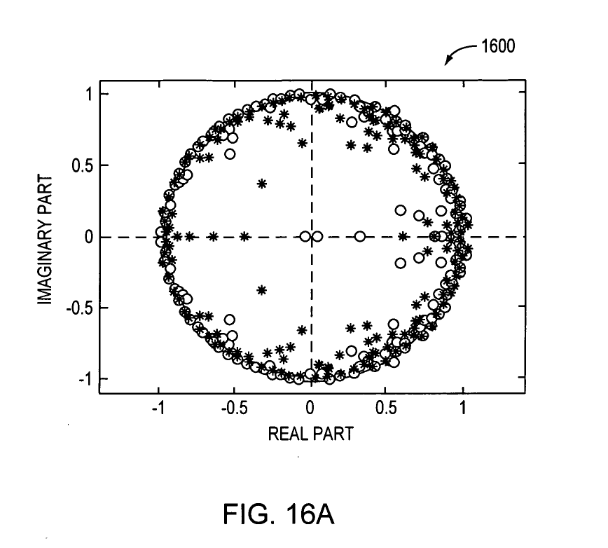

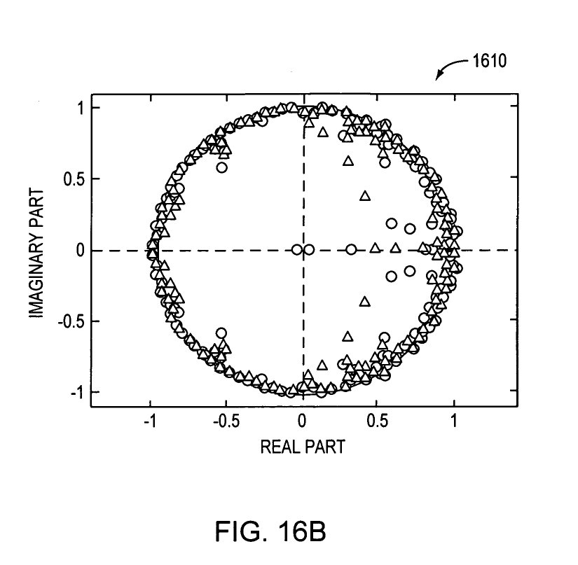

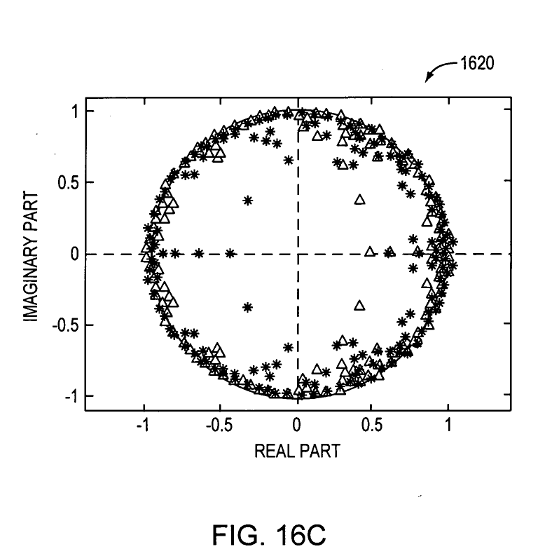

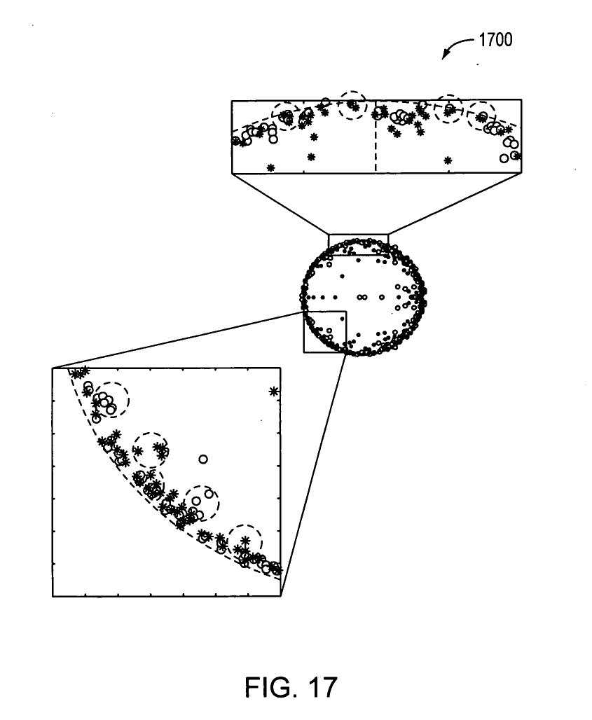

FIGS. 16A, 16B, and 16C are graphs 1600, 1610, 1620 showing complex roots of predictor coefficient vectors in the application of an autoregressive filter to chromatographic data of bacteria headspace. The graph 1600 of FIG. 16A shows the roots of the predictor coefficients of the data sets from E. coli and M. smegmatis, where O=E. coli (n=7), *=M. smegmatis (n=7), and Δ=B. subtilis (n=7). The roots of the two species clearly do not have the same pattern. The same is true for the comparison of E. coli with B. subtilis and M. smegmatis with B. subtilis shown in plots 1610 and 1620 of FIGS. 16B and 16C. This is also shown in the plot 1700 of FIG. 17, where portions of the graph comparing E. coli and M. smegmatis have been expanded for easier viewing. In the upper expanded portion, the roots that closely overlap have been circled. These points would not be useful for pattern recognition because the two species cannot be distinguished at these points. However, in the lower expanded portion, areas where the roots of only one of the species are clustering together have been circled. These areas may prove useful for pattern recognition and classification.

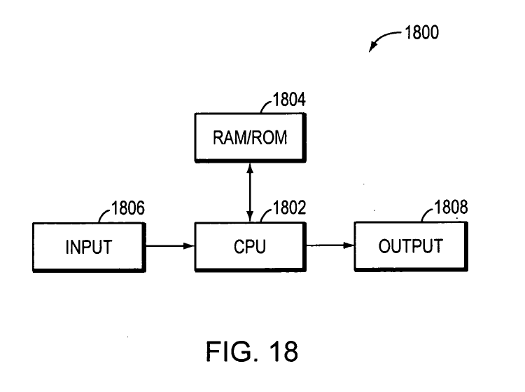

FIG. 18 is a schematic 1800 depicting a computer hardware apparatus 1800 suitable for use in carrying out any of the methods described herein. The apparatus 1800 may be a portable computer, a desktop computer, a mainframe, or other suitable computer having the necessary computational speed and accuracy to support the functionality discussed herein. The computer 1800 typically includes one or more central processing units 1802 for executing the instructions contained in the software code which embraces one or more of the methods described herein. Storage 1804, such as random access memory and/or read-only memory, is provided for retaining the code, either temporarily or permanently, as well as other operating software required by the computer 1800. Permanent, non-volatile read/write memory such as hard disks are typically used to store the code, both during its use and idle time, and to store data generated by the software. The software may include one or more modules recorded on machine-readable media such as magnetic disks, magnetic tape, CD-ROM, and semiconductor memory, for example. Preferably, the machine-readable medium is resident within the computer 1800. In alternative embodiments, the machine-readable medium can be connected to the computer 1800 by a communication link. For example, a user of the software may provide input data via the internet, which is processed remotely by the computer 1800, and then output is sent to the user. In alternative embodiments, one can substitute computer instructions in the form of hardwired logic for software, or one can substitute firmware (i.e., computer instructions recorded on devices such as PROMs, EPROMs, EEPROMs, or the like) for software. The term machine-readable instructions as used herein is intended to encompass software, hardwired logic, firmware, object code, and the like.

The computer 1800 is preferably a general purpose computer. The computer 1800 can be, for example, an embedded computer, a personal computer such as a laptop or desktop computer, a server, or another type of computer that is capable of running the software, issuing suitable control commands, and recording information. The computer 1800 includes one or more inputs 1806, such as a keyboard and disk reader for receiving input such as data and instructions from a user, and one or more outputs 1808, such as a monitor or printer for providing results in graphical and other formats. Additionally, communication buses and I/O ports may be provided to link all of the components together and permit communication with other computers and computer networks, as desired.

### Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A method for temporally aligning chromatograms representative of complex mixture samples, the method comprising the steps of:
(a) providing first and second chromatograms;
(b) identifying pairs of related peaks in the first and second chromatograms;
(c) computing a temporal offset for each of at least two pairs of related peaks; and
(d) applying a nonlinear temporal shift based on the computed temporal offsets to align the first and second chromatograms.

2. The method of claim 1, wherein step (d) comprises determining a nonlinear functional relationship between temporal offset and retention time based on the computed temporal offsets, and aligning the first and second chromatograms based on the nonlinear functional relationship.

3. The method of claim 2, wherein the nonlinear functional relationship is a cubic spline interpolation or a cubic hermite interpolating polynomial.

4. The method of claim 1, wherein step (b) comprises identifying candidate pairs of peaks and determining whether the candidate pairs of peaks are related.

5. The method of claim 4, wherein step (b) comprises rejecting unrelated candidate pairs.

6. The method of claim 4, wherein step (b) comprises imposing a minimum correlation between M/Z values of related peaks.

7. The method of claim 1, wherein step (b) is performed automatically.

8. The method of claim 1, wherein steps (b), (c), and (d) are performed automatically.

9. The method of claim 1, wherein the first chromatogram is a composite of two or more chromatograms.

10. The method of claim 1, wherein the first chromatogram comprises discrete data.

11. The method of claim 1, wherein the first and second chromatograms comprise gas chromatographic (GC) data.

12. The method of claim 1, wherein the first and second chromatograms comprise GC-MS data.

13. The method of claim 1, further comprising the step of:
(e) classifying a complex mixture sample using at least a portion of at least one of the aligned chromatograms.

14. The method of claim 13, wherein the complex mixture sample is a biological mixture.

15. The method of claim 13, wherein the complex mixture sample is plasma, blood, urine, bacteria, or an extract of plasma, blood, urine, or bacteria.

16. A method for temporally aligning chromatograms representative of complex mixture samples, the method comprising the steps of:
(a) providing a plurality of chromatograms;
(b) identifying sets of related peaks among at least two of the chromatograms;
(c) computing a temporal offset for each of at least two sets of related peaks; and
(d) applying a nonlinear temporal shift based on the computed temporal offsets to align the plurality of chromatograms.

17. A method for filtering at least one chromatogram representative of a complex mixture sample, the method comprising the steps of:
(a) providing a chromatogram representative of a complex mixture sample; and
(b) applying an autoregressive filter to process data from the chromatogram.

18. The method of claim 17, wherein step (b) comprises transforming chromatographic data from frequency domain data to time domain data.

19. The method of claim 18, wherein step (b) comprises computing predictor parameters to determine an impulse response corresponding to data from the chromatogram.

20. The method of claim 19, further comprising the step of:
(c) identifying a feature of the chromatogram using the predictor parameters.

21. The method of claim 19, further comprising the step of:
(c) applying a Fourier transform to the impulse response to obtain a model chromatogram.

22. The method of claim 17, wherein step (a) comprises providing a plurality of chromatograms representative of complex mixture samples, and wherein step (b) comprises applying the autoregressive filter to smooth data from the chromatograms.

23. The method of claim 22, wherein step (b) comprises computing predictor parameters to determine an impulse response for each of the chromatograms.

24. The method of claim 23, further comprising the step of:
(c) identifying a pattern in the chromatograms using the predictor parameters.

25. The method of claim 17, wherein step (b) comprises increasing signal-to-noise ratio of the chromatogram without substantially broadening peaks of the chromatogram.

26. The method of claim 17, wherein step (b) comprises resolving at least partially overlapping peaks of the chromatogram.

27. The method of claim 17, wherein the chromatogram comprises gas chromatographic (GC) data.

28. The method of claim 17, wherein the chromatogram comprises GC-MS data.

29. The method of claim 17, further comprising the step of:
(c) classifying the complex mixture sample using at least a portion of the processed data.

30. The method of claim 17, wherein the complex mixture sample is a biological mixture.

31. The method of claim 17, wherein the complex mixture sample is plasma, blood, urine, bacteria, or an extract of plasma, blood, urine, or bacteria.

32. A method for aligning and filtering chromatograms representative of complex mixture samples, the method comprising the steps of:
(a) providing a plurality of chromatograms;
(b) applying a nonlinear temporal shift to align at least two of the chromatograms; and
(c) applying an autoregressive filter to smooth data from at least one of the aligned chromatograms.

33. The method of claim 32. wherein step (b) comprises identifying related peaks from the chromatograms, computing temporal offsets corresponding to the related peaks, and determining the nonlinear temporal shift.

34. The method of claim 32, wherein step (c) comprises computing predictor parameters to determine an impulse response for each of the chromatograms and applying a Fourier transform to each of the impulse responses to obtain model chromatograms.

35. The method of claim 32, wherein the chromatograms comprise gas chromatographic (GC) data.

36. The method of claim 32, wherein the chromatograms comprise GC-MS data.

37. The method of claim 32, further comprising the step of:
(d) classifying a complex mixture sample using at least a portion of at least one of the aligned and smoothed chromatograms.

38. The method of claim 37, wherein the complex mixture sample is a biological mixture.

39. The method of claim 37, wherein the complex mixture sample is plasma, blood, urine, bacteria, or an extract of plasma, blood, urine, or bacteria.
